(19) United States
(12) Patent Application Publication
(10) Pub. No.: US 2022/0327096 A1
(43) Pub. Date: Oct. 13, 2022

(54) COMPUTER-READABLE RECORDING MEDIUM STORING INCOMPATIBILITY DETECTION PROGRAM, INCOMPATIBILITY DETECTION METHOD, AND INCOMPATIBILITY DETECTION APPARATUS

(71) Applicant: FUJITSU LIMITED, Kawasaki-shi (JP)

(72) Inventors: Tsuyoshi SATO, Noda (JP); Tsubasa Yamamoto, Yokohama (JP); Toshihide Nakatsu, Yokohama (JP); TAKAHIRO NAGAO, Numazu (JP); Takashi HASHIMOTO, Ota (JP)

(73) Assignee: FUJITSU LIMITED, Kawasaki-shi (JP)

(21) Appl. No.: 17/592,748

(22) Filed: Feb. 4, 2022

(30) Foreign Application Priority Data
Apr. 9, 2021 (JP) 2021-066531

(51) Int. Cl. G06F 16/11; G06F 16/18; G06F 11/14

(52) U.S. Cl. CPC G06F 16/119; G06F 16/18; G06F 11/1435

(57) ABSTRACT

A non-transitory computer-readable recording medium stores an incompatibility detection program causing a computer to execute a process including: identifying a type of a setting file of an application that operates in a first application execution environment; and detecting an incompatibility that occurs in the setting file of which the type is identified, by applying merely an incompatibility detection rule corresponding to the identified type of the setting file among one or more incompatibility detection rules in each of which information on an incompatibility detection pattern for determining that the setting file includes an incompatibility that occurs along with migration from the first application execution environment to a second application execution environment different from the first application execution environment and information on the type of the setting file in which the incompatibility occurs are associated with each other.

### CROSS-REFERENCE TO RELATED APPLICATION

This application is based upon and claims the benefit of priority of the prior Japanese Patent Application No. 2021-66531, filed on Apr. 9, 2021, the entire contents of which are incorporated herein by reference.

### FIELD

The embodiment discussed herein is related to a computer-readable recording medium storing an incompatibility detection program, an incompatibility detection method, and an incompatibility detection apparatus for detecting an incompatibility that causes a problem when an application execution environment is migrated.

### BACKGROUND

In the related art, an application executed in an information processing apparatus has been created in accordance with an application execution environment (system environment) for executing the application. When an application execution environment is migrated to a different execution environment, a so-called incompatibility problem may occur. An incompatibility indicates that all or a part of applications executable in an application execution environment of a migration source may not be executed (or may not normally operate) in an application execution environment after the migration. For example, as for Java, it is known that an incompatibility occurs at the time of migration from Java 2 Platform, Enterprise Edition (J2EE) to Jakarta Enterprise Edition (Jakarta EE) along with a version upgrade of an application execution environment. disclosed as related art.

### SUMMARY

According to an aspect of the embodiments, a non-transitory computer-readable recording medium stores an incompatibility detection program causing a computer to execute a process including: identifying a type of a setting file of an application that operates in a first application execution environment; and detecting an incompatibility that occurs in the setting file of which the type is identified, by applying merely an incompatibility detection rule corresponding to the identified type of the setting file among one or more incompatibility detection rules in each of which information on an incompatibility detection pattern for determining that the setting file includes an incompatibility that occurs along with migration from the first application execution environment to a second application execution environment different from the first application execution environment and information on the type of the setting file in which the incompatibility occurs are associated with each other.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a functional block diagram of an incompatibility detection apparatus;

FIG. 2 illustrates an example of a file type definition file;

FIG. 3 illustrates an example of a file type identifying keyword list;

FIG. 4A illustrates an example of a system definition information file of which a file type may be identified;

FIG. 4B illustrates an example of a system definition information file of which a file type may not be identified;

FIG. 5 illustrates an example of an assessment profile;

FIG. 6 illustrates an example of a rule set definition file;

FIG. 7A illustrates an example of a rule definition file;

FIG. 7B illustrates an example of a rule definition file;

FIG. 8 illustrates an example of a list of incompatibility detection rules;

FIG. 9 illustrates a flowchart of input and output processing of a system definition information file;

FIG. 10 illustrates a flowchart of incompatibility detection processing;

FIG. 11 illustrates a flowchart of incompatibility detection rule application processing to a system definition information file;

FIG. 12 illustrates a diagram illustrating an example of a comma-separated values (CSV) report file to be output;

FIG. 13 illustrates an example of a system definition information file; and

FIG. 14 illustrates a block diagram exemplifying a hardware configuration of the incompatibility detection apparatus.

### DESCRIPTION OF EMBODIMENTS

Since an incompatibility occurs along with migration of an application execution environment, a portion defining this application execution environment is provided outside a source code of the application. Accordingly, it is possible to avoid the incompatibility merely by correcting the portion that is provided outside without correcting the source code itself. A file in which the application execution environment is defined outside the source code is referred to as a system definition information file in the present application. The system definition information file is a type of a setting file of an application.

A technique for automating detection of an incompatibility in an application is known. For example, in a technique of the related art, an information processing apparatus that executes an application in a second application execution environment at least a part of which is incompatible with a first application execution environment stores incompatibility detection rules called a manifest of the application. By checking the application based on the manifest, an incompatibility of the application in the second application execution environment is detected.

In the technique of the related art, when an incompatibility of an application is checked, all the incompatibility detection rules are applied to all the system definition information files of the application. In recent years, the number of incompatibility detection rules has become enormous due to complication or the like of an application execution environment. For example, in a case where an execution environment is migrated from J2EE to Jakarta EE, 300 or more incompatibility detection rules are assumed. As the scale of an application increases, a large number of system definition information files to be analyzed are expected to exist (in one case, approximately 1500 files exist per server, and the number of servers included in an information processing system may be 100 or more). For this reason, there is a problem that checking the incompatibility detection rules for all the system definition information files one by one increases the time taken to detect an incompatibility.

In view of the above-described problem, according to one aspect of the present disclosure, it is an object to provide a technique capable of reducing time taken to detect an incompatibility that occurs in a setting file along with migration of an application execution environment.

An embodiment for implementing the present disclosure will be described with reference to the drawings. The present embodiment is one of modes for realizing the disclosure, and contents, an execution order, and the like of each processing in the embodiment may be changed as appropriate within a range in which the disclosure may be realized.

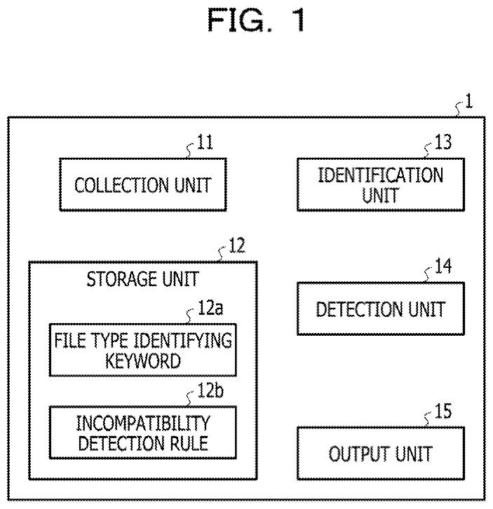

FIG. 1 is a functional block diagram of an incompatibility detection apparatus according to the present embodiment. An incompatibility detection apparatus 1 includes a collection unit 11, a storage unit 12, an identification unit 13, a detection unit 14, and an output unit 15. The collection unit 11 collects a system definition information file included in an application before migration.

The storage unit 12 stores a file type identifying keyword 12a and an incompatibility detection rule 12b. For example, the storage unit 12 corresponds to a semiconductor memory element such as a random-access memory (RAM), a read-only memory (ROM), or a flash memory; or a storage device such as a hard disk drive (HDD). The file type identifying keyword 12a and the incompatibility detection rule 12b will be described later.

The identification unit 13 determines a type of a system definition information file of an application. As described above, the system definition information file is a type of a setting file of the application.

By applying an incompatibility detection rule selected based on the type of the system definition information file identified by the identification unit 13, the detection unit 14 detects an incompatibility included in the system definition information file.

For example, the output unit 15 outputs information on the incompatibility detected by the detection unit 14 to a report file.

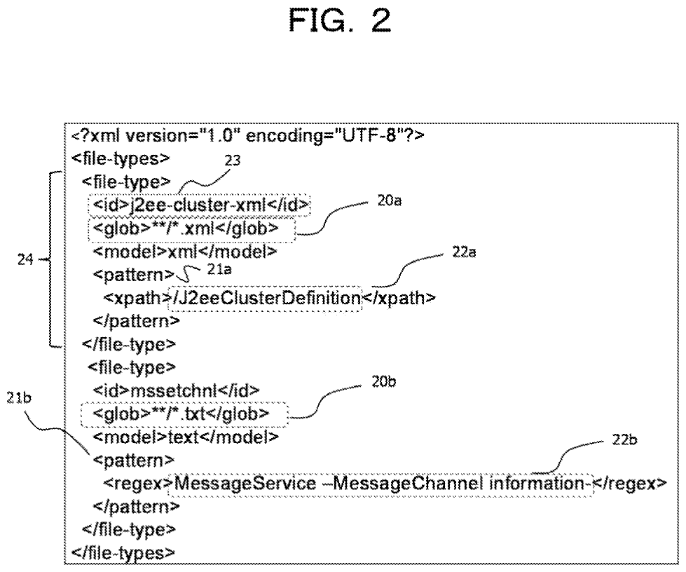

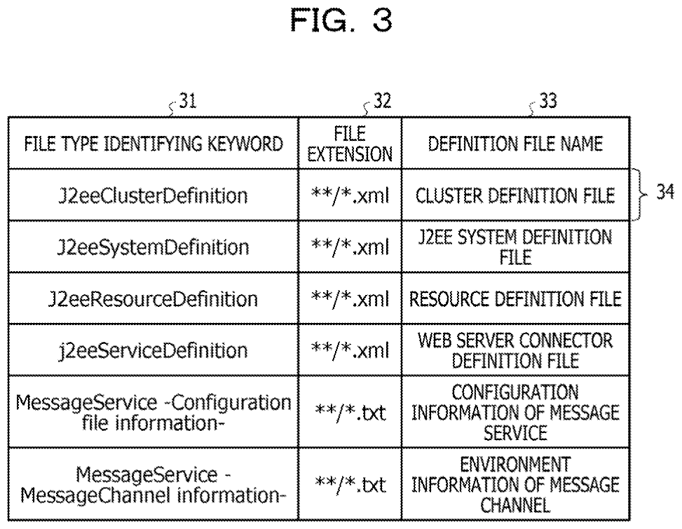

FIG. 2 illustrates an example of a file type definition file used to define each file type included in the system definition information file. The file type is information indicating which function among a plurality of functions installed in a product the system definition information file is for. For example, descriptions 20a and 20b define file extensions. For example, the file extension defined by the description 20a is “.xml”. On the other hand, from the description 20b, it is understood that the defined file extension is “.txt”. The items described in ranges of a tag “pattern” indicated by descriptions 21a and 21b define patterns representing conformity conditions. There are “xpath” and “regex” as subtags of the descriptions 21a and 21b. “xpath” defines “XPath” representing the conformity condition, and “regex” defines a regular expression representing the conformity condition. Description 22a and 22b in FIG. 2 indicate file type identifying keywords defined by “xpath” and “regex”, respectively. A file type identifying keyword list illustrated in FIG. 3 is created by using the file extensions and the information on the file type identifying keywords obtained from the file type definition file.

FIG. 3 illustrates a file type identifying keyword list in which file type identifying keywords 31 and file extensions 32 associated with each other are listed. The file type identifying keyword for each type of the system definition information file is known, and may be stored in the storage unit 12. In this case, as illustrated in FIG. 3, in the file type identifying keyword list, the file type identifying keywords 31, the file extensions 32, and system definition file names 33 are associated with each other. For example, as described in a data line 34 in FIG. 3, it is indicated in a Cluster definition file that a file type identifying keyword “J2eeClusterDefinition” exists in the Cluster definition file, and the file name and the file type identifying keyword are associated with each other. A list of information obtained from the file type definition file is the file type identifying keyword list illustrated in FIG. 3. Although FIG. 3 is illustrated as a list for easy viewing, the file type identifying keyword list does not have to be summarized as a list. The file type identifying keyword and the file extension may be associated with each other for each type. The system definition information file described herein is an example, and is not limited to the one described herein.

A method of identifying a type of a file will be described next. A format of the system definition information file is determined. It is known that in a case where the file type identifying keyword 31 exists, the file type identifying keyword 31 illustrated in FIG. 3 appears at a predetermined description position in the file, for example, in a portion from the head to the second line of the file. Thus, the identification unit 13 first opens the system definition information file to be analyzed, and reads, for example, the portion from the head to the second line of the file. When the file type identifying keyword appears, the identification unit 13 identifies the type of the file by referring to the file type identifying keyword list in FIG. 3. When the file type identifying keyword does not appear, the identification unit 13 does not read the third and subsequent lines of the file and closes the file. The reading target portion of the system definition information file is not necessarily limited to the described-above portion from the head to the second line of the file. The reading target portion of the system definition information file may be changed as appropriate in accordance with a format of the system definition information file or a configuration of the information processing system.

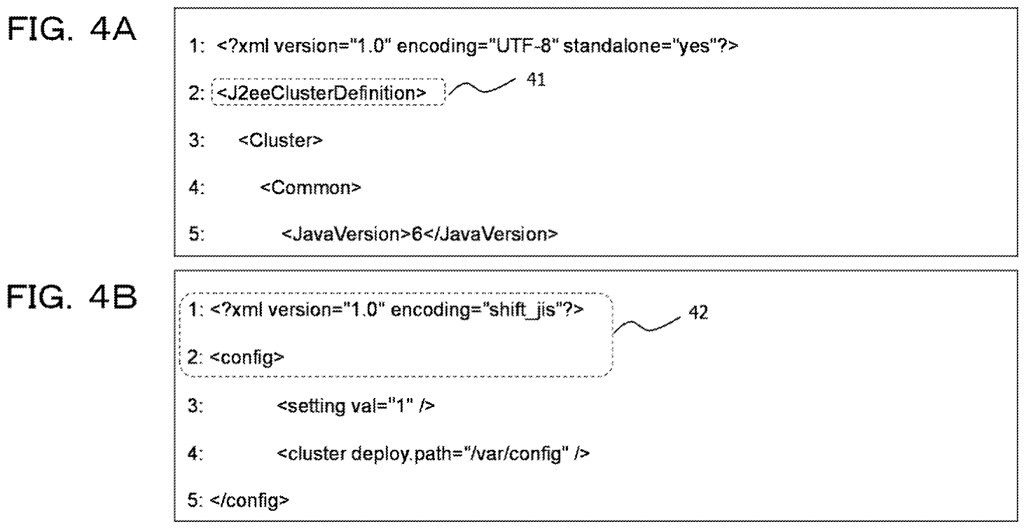

FIG. 4A is an example of a system definition information file of which a file type may be identified, and FIG. 4B is an example of a system definition information file of which a file type may not be identified. For example, in FIG. 4A, a file type identifying keyword “J2eeClusterDefinition” appears in a portion 41 on the second line of the system definition information file. Thus, the identification unit 13 may refer to the file type identifying keyword list in FIG. 3 and identify that the system definition information file in FIG. 4A is a Cluster definition file. On the other hand, when the file type identifying keyword does not appear in a portion 42 up to the second line as in FIG. 4B, the identification unit 13 may not identify the type of the system definition information file. Although the file is read up to the second line because the file type identifying keyword appears on the second line in FIG. 4A, when the file type identifying keyword appears on the first line, the identification unit 13 may omit subsequent reading processing.

In the present embodiment, the file types described in the file type identifying keyword list in FIG. 3 are file types for which an incompatibility may occur among all the system definition information files. Accordingly, in the present embodiment, a system definition information file of which a file type is not identified (for example, a system definition information file of a type that is not indicated in the file type identifying keyword list) may be regarded as a system definition information file for which there is no possibility of the occurrence of an incompatibility.

For this reason, incompatibility detection processing to be described later may not be performed on a file of which a file type is not identified, such as the file illustrated in FIG. 4B. In this case, since the incompatibility detection processing is omitted for the file of which the file type is not identified among the plurality of system definition information files, the time taken for the incompatibility detection may be reduced as a whole.

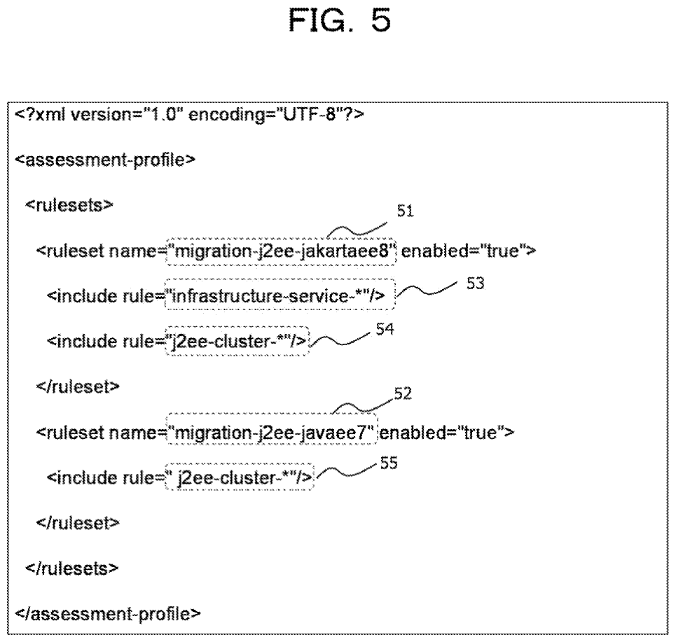

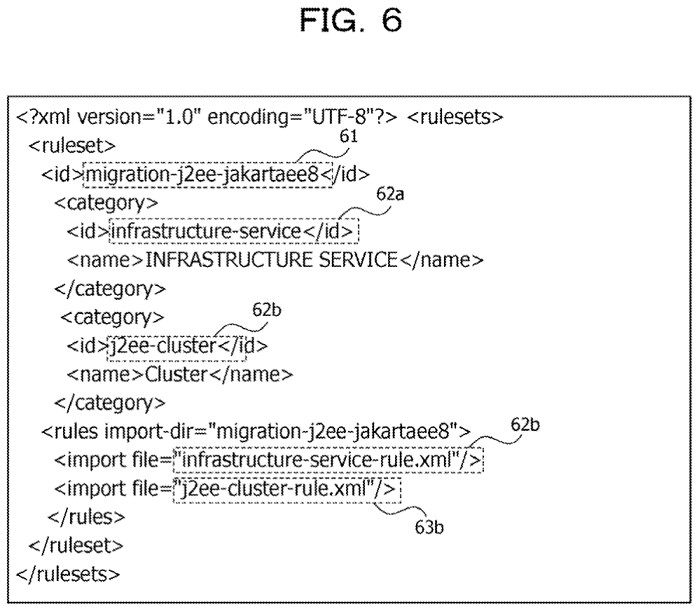

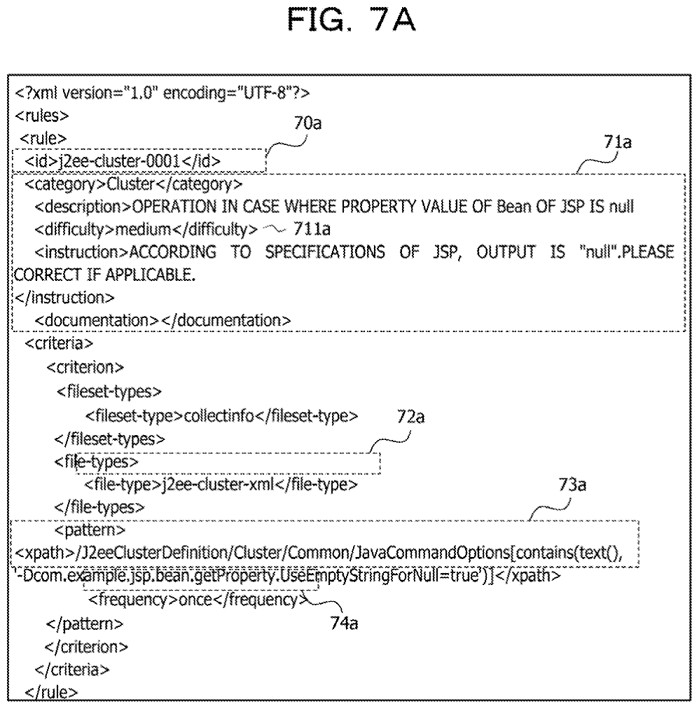

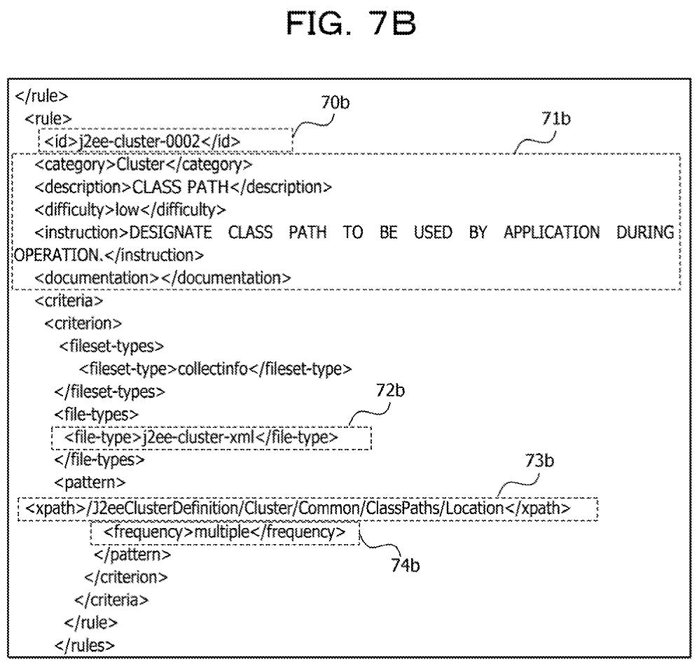

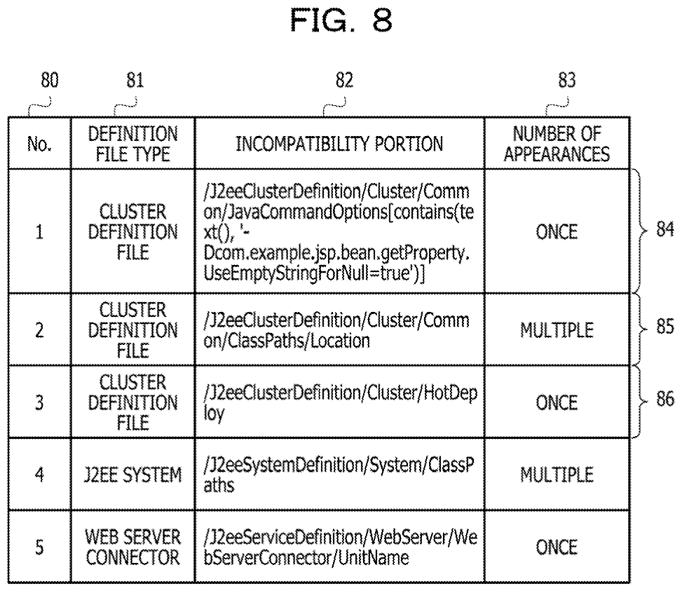

A process of creating an incompatibility detection rule will be described by using FIGS. 5, 6, 7A, and 7B. The incompatibility detection rule is obtained by associating a file type with an incompatibility portion that may appear for the file type (refer to FIG. 8). The incompatibility detection rule is obtained by defining information obtained from an assessment profile (FIG. 5), a rule set definition file (FIG. 6), and a rule definition file (FIGS. 7A and 7B).

FIG. 5 is a diagram illustrating an example of the assessment profile. The assessment profile is a file that defines setting of an assessment, and a list of a set of a plurality of incompatibility detection rules (hereinafter, may be referred to as a rule set) to be applied is described. Descriptions 51 and 52 in FIG. 5 indicate rule sets applied when an application is migrated to a new environment.

For example, the description 51 in FIG. 5 includes a description “migration-j2ee-jakartaee8” and defines a rule set applied when the application execution environment is migrated from a J2EE environment to a Jakarta EE 8 environment. Similarly, the description 52 includes a description “migration-j2ee-javaee7” and indicate a rule set in a case where the application execution environment is migrated from the J2EE environment to a Java EE 7 environment. The descriptions 51 and 52 are rule set IDs of rule set definition files described later. Descriptions 53 and 54 are rule IDs of the rule definition files in the case where the application execution environment is migrated from the J2EE environment to the Jakarta EE 8 environment. The rule definition files will be described later by using FIGS. 7A and 7B.

A description 55 indicates a rule ID of the rule definition file in the case where the application execution environment is migrated from the J2EE environment to the Java EE 7 environment. As described above, in a case where there is a description “include” immediately before the rule ID, a rule that is a sum set of rules designated by “include” is applied.

In a case where there is no description “include”, all the rules included in the rule set are applied. Although not illustrated, in a case where there is a description “exclude” before the notation of the rule ID, the rule is a rule to be excluded from the rule ID. In a case where a contradiction occurs in the settings of “include” and “exclude”, the setting of “exclude” is prioritized.

FIG. 6 illustrates an example of the rule set definition file. A set of incompatibility detection rules is described in the rule set definition file. A description 61 in FIG. 6 indicates that “migration-j2ee-jakartaee8” that is designated in the description 51 of the assessment profile described in FIG. 5 is a rule set ID. Descriptions 62a and 62b define categories of the incompatibility that may occur for the rule set having the ID designated by the description 61. For example, the description 62a indicates that the rule is a rule related to an infrastructure service, and the description 62b indicates that the rule is a rule related to Cluster. In descriptions 63a and 63b, file names that may be the rule definition files are described.

FIGS. 7A and 7B each illustrate an example of the rule definition file that is the rule definition file indicated by the description 63b in FIG. 6. FIG. 7A describes a case where the rule ID is “j2ee-cluster-0001”, and FIG. 7B describes a case where the rule ID is “j2ee-cluster-0002”. Descriptions 70a and 70b are rule IDs. Descriptions 71a and 71b are collections of items described in a report file described later. Descriptions 711a and 711b indicate difficulty levels at the time of migration. For example, the difficulty level is defined by three steps “high”, “medium”, and “low”. In an example, “high” is described in a case where there is no correction method and an alternative is to be considered, “medium” is described in a case where replacement and code correction of a related portion are to be made for correction, and “low” is described in a case where replacement is to be made for correction. Descriptions 72a and 72b define the file type corresponding to the rule ID. A character string described in the descriptions 72a and 72b refer to a character string that is the id described in the description 23 in FIG. 2, and the type of the file is determined by this character string. For example, in the description 24 in FIG. 2, a character string “j2ee-cluster-xml” is given as the id described in the description 23 to a file that is an xml file with a file extension of .xml from the description 20a and includes a file type identifying keyword “J2eeClusterDefinition” (the description 22a). For this reason, it is understood from the character string “j2ee-cluster-xml” of the descriptions 72a and 72b that each file has the file type identifying keyword “J2eeClusterDefinition” (the description 22a). As described above, in a case where the file name corresponding to the file type identifying keyword is stored in the storage unit 12, it is also possible to identify that the file that is an xml file and that includes the file type identifying keyword “J2eeClusterDefinition” is the Cluster definition file.

Descriptions 73a and 73b describe an incompatibility detection pattern for determining that the system definition information file of the corresponding type includes incompatibility. The incompatibility detection pattern includes a position where the incompatibility exists and a character string of an incompatibility detection keyword. Descriptions 74a and 74b stipulate the maximum numbers of times the incompatibility detection keywords described in the descriptions 73a and 73b appear in the system definition information file. For example, “once” is described in the description 74a, which indicates that the number of times the incompatibility detection keyword described in the description 73a appears in the corresponding file is one at maximum. “multiple” is described in the description 74b, which represents that the incompatibility detection keyword in the description 73b may appear a plurality of times in the corresponding file. However, as another configuration, for example, a configuration may be employed in which the number of times the incompatibility detection keyword appears in the system definition information file is specifically designated such as twice or three times.

By preparing the assessment profile and the rule set definition file, in a case where there are a plurality of combinations of migration sources and migration destinations of an execution environment of an application, a rule definition file having duplicated contents is no longer to be created for each combination of the migration source and the migration destination. For this reason, in the rule definition file, it is possible to define the list of the incompatibility detection rules to be applied without redundant description.

FIG. 8 is an explanatory diagram illustrating an example of a list of incompatibility detection rules. For example, the list of the incompatibility detection rules illustrated in FIG. 8 is created by referring to the rule definition files illustrated in FIGS. 7A and 7B.

In an incompatibility detection rule, a definition file type 81, an incompatibility portion 82, and a number of appearances 83 are associated with each other. The incompatibility portion 82 indicates a portion where the incompatibility occurs when the execution environment of the application is migrated, and corresponds to the incompatibility detection keyword. Numbers are used in a portion “No.” 80 in the present embodiment, but the notation is not limited to the numbers, and for example, alphabets and the rule IDs of the descriptions 70a and 70b of FIGS. 7A and 7B may be used.

Incompatibility detection processing according to the present embodiment will be described next.

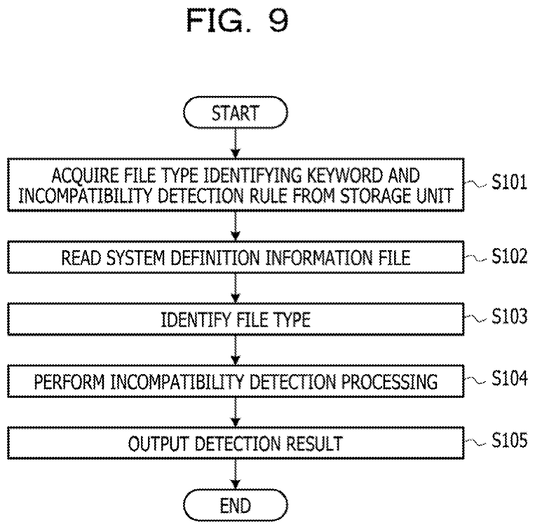

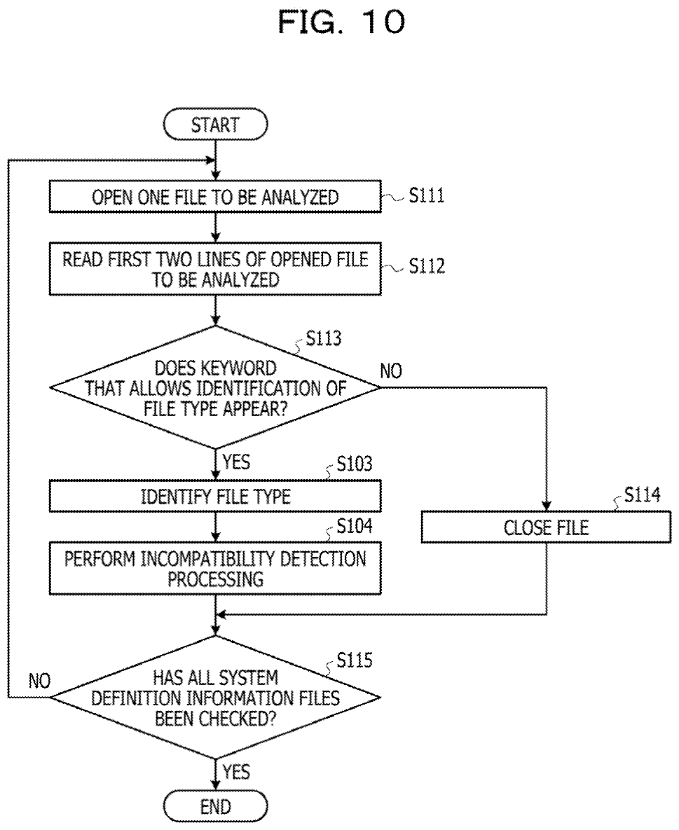

FIGS. 9 and 10 are flows of processing performed by the incompatibility detection apparatus on a system definition information file. First, input and output processing of the system definition information file will be described with reference to FIG. 9.

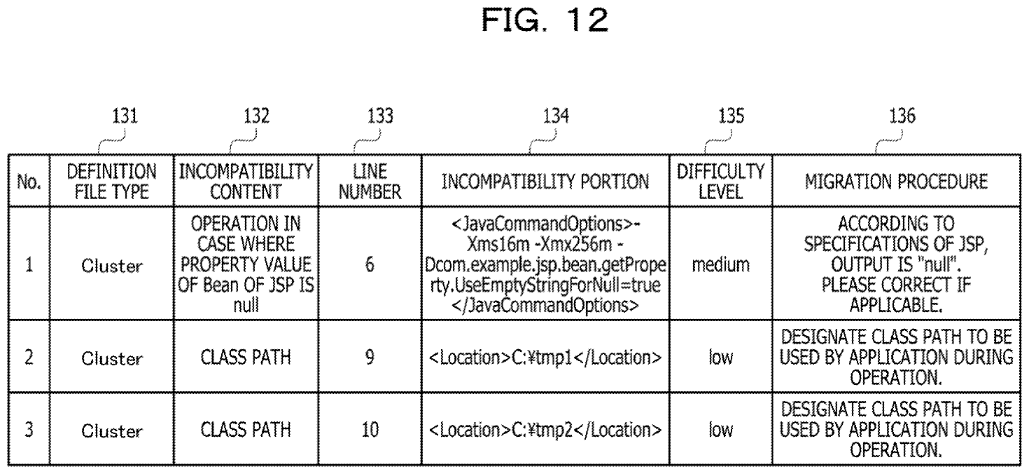

In step S101, the detection unit 14 acquires the file type identifying keyword 12a and the incompatibility detection rule 12b stored in the storage unit 12. In step S102, the collection unit 11 reads the system definition information file of the application. In step S103, the identification unit 13 identifies the type of the system definition information file read in step S102. In step S104, the detection unit 14 detects an incompatibility that occurs in the file the type of which is identified in step S103. In step S105, the output unit 15 outputs information on the detected incompatibility to the report file. As the information on the incompatibility, for example, the output unit 15 may output an incompatibility portion, a difficulty level, a migration procedure, or the like to the report file. As described above, the incompatibility portion indicates a portion where the incompatibility occurs when the execution environment of the application is migrated. As described above, the difficulty level indicates the difficulty level at the time of the migration. The migration procedure describes a specific method of correcting the incompatibility that occurs. The report file will be described later by using FIG. 12. Although the output unit 15 outputs the detection result every time the detection of the incompatibility of one file ends in the present embodiment, the configuration is not limited to this. For example, the output unit 15 may close a file every time incompatibility detection ends for each file, and open the file again after detecting the incompatibility of all the system definition information files, thereby outputting the detection result to the report file.

FIG. 10 exemplifies details of a flow of the processing in steps S102 to S104 of FIG. 9. The processing in steps S103 and S104 described in FIG. 10 is the same as the processing in steps S103 and S104 described in FIG. 9.

Among the system definition information files of the application, the identification unit 13 opens one file that has not been processed (S111).

The identification unit 13 reads a portion from the head to the second line of the file opened in step S111 (S112). In step S113, the identification unit 13 determines whether or not a file type identifying keyword for identifying a file type appears in the read portion. At this time, in a case where the file type identifying keyword appears (in a case of Yes in S113), the identification unit 13 identifies the type of the file corresponding to the file type identifying keyword that appears (S103), and performs the processing in step S104. When the file type identifying keyword does not appear (in a case of No in S113), since the file is a file of which the file type is not identified, the identification unit 13 closes the file (S114) and the processing proceeds to step S115.

In step S104, the detection unit 14 detects the incompatibility that occurs in the system definition information file. The method for detecting an incompatibility will be described later. Even in a case of the system definition information file of which the file type may be identified, when the corresponding incompatibility detection rule does not exist, the processing may proceed to step S115 without performing the incompatibility detection processing. Accordingly, it is possible to reduce the number of system definition information files to be analyzed on which the incompatibility detection processing is performed, and to shorten the incompatibility detection time.

In step S115, the identification unit 13 determines whether or not all the system definition information files (system definition information files to be processed) of the application have been checked. In a case where all the system definition information files have been checked (in a case of Yes in S115), the series of processing illustrated in FIG. 10 ends. In a case where there is a system definition information file that has not been checked yet (in a case of No in S115), the processing returns to step S111, and the processing of steps S111 to step S115 is repeated.

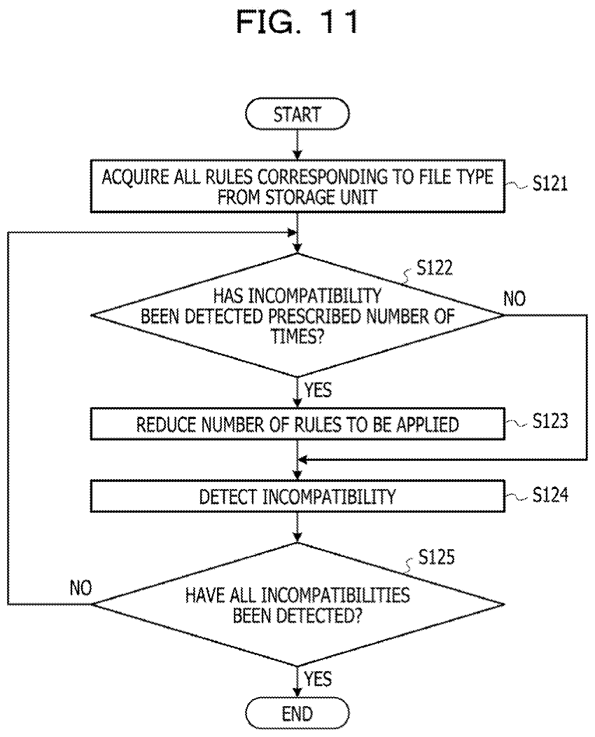

The incompatibility detection processing in step S104 will be described. Detection of an incompatibility that occurs in the system definition information file is performed by the detection unit 14 applying an incompatibility detection rule corresponding to the type of the file. The detection unit 14 may apply a plurality of incompatibility detection rules corresponding to the identified file type until all the incompatibilities that occur in the file are detected, or may reduce the number of incompatibility detection rules to be applied in accordance with the numbers of appearances of the detected incompatibilities. This processing will be described later by using FIG. 11.

According to the above-described procedure, the incompatibility detection processing may be performed on the system definition information file to be analyzed by applying merely the incompatibility detection rule corresponding to the type of the file without applying all the incompatibility detection rules. Accordingly, the number of incompatibilities to be checked for one system definition information file is reduced as compared with the method in the related art. As a result, an effect is obtained in which the processing time taken to detect the incompatibility in the system definition information file is reduced.

According to the present embodiment, during a period from opening to closing of one file to be analyzed, the incompatibility detection is performed by identifying the type of the system definition information file to be analyzed and by applying the incompatibility detection rule corresponding to the identified type of the system definition information file. On the other hand, in the method in the related art, for each single incompatibility, whether or not the incompatibility occurs is checked for all the system definition information files. At this time, in the method in the related art the same number of files as the number of system definition information files to be processed are to be opened and closed for each incompatibility. Thus, in the present embodiment, the number of times of file opening and closing processing may be reduced as compared with the method in the related art.

As described above, by performing the incompatibility detection processing by applying merely the incompatibility detection rule corresponding to the type of the system definition information file, the number of incompatibilities to be checked for one system definition information file is reduced as compared with the method in the related art. In a case where the number of incompatibility detection rules to be applied is reduced in accordance with the number of appearances of detected incompatibility while the incompatibility detection processing is being performed, the number of incompatibilities to be checked for one system definition information file may be further reduced.

An example of the incompatibility detection processing performed while reducing the number of incompatibility detection rules in a process of detecting incompatibility from the system definition information file will be described with reference to FIG. 11.

FIG. 11 is a flow of incompatibility detection rule application processing, illustrating an example of a flow of the incompatibility detection processing in step S104 in FIG. 9. Among the incompatibility detection rules stored in the storage unit 12, the detection unit 14 acquires all the incompatibility detection rules corresponding to the type of the system definition information file (S121). The detection unit 14 determines whether or not the incompatibility has been detected in the file to be analyzed as many times as the number of appearances (the number of appearances 83 illustrated in FIG. 8) described in the acquired incompatibility detection rule (S122). In a case where the incompatibility has been detected from the file to be analyzed as many times as the prescribed number of times (in a case of Yes in S122), the detection unit 14 excludes the incompatibility detection rule for which the incompatibility has appeared the prescribed number of times (S123). For example, the detection unit 14 reduces the number of incompatibility detection rules to be applied in the subsequent processing, and then proceeds to the incompatibility detection in step S124. In a case where the incompatibility has not been detected from the system definition information file as many times as the prescribed number of times (in a case of No in S122), the detection unit 14 detects the incompatibility without reducing the number of incompatibility detection rules to be applied (S124). In step S125, the detection unit 14 checks whether or not all the incompatibilities that occur in the file to be analyzed have been detected. In a case where all the incompatibilities have been detected (in a case of Yes in S125), the incompatibility detection processing ends. In a case where all the incompatibilities have not been detected (in a case of No in S125), the processing returns to step S122 and the processing of steps S122 to S125 is repeated.

FIG. 12 is a diagram illustrating an example of a report file output by the output unit 15. Items to be output to the report file by the output unit 15 are created by referring to the rule definition files illustrated in FIGS. 7A and 7B. Although the example illustrated in FIG. 12 indicates a configuration in which descriptions 131 to 136 are included as the items of the report file, information corresponding to other items may be included. Alternatively, the items of the report file may be a part of items selected from the descriptions 131 to 136.

A definition file type in the description 131 is information indicating a type of a file in which an incompatibility occurs, and is determined by the descriptions 72a and 72b in FIG. 7. For example, from FIGS. 7A and 7B, it is understood that both file types are the Cluster definition file. In an incompatibility content in the description 132, the items described in “description” of descriptions 71a and 71b of FIGS. 7A and 7B are output. The incompatibility content is a summary of the detected incompatibility. A line number in the description 133 indicates a position (line number) where the incompatibility appears in the system definition information file. In an incompatibility portion in the description 134, an incompatibility detection keyword that has appeared on the line of the line number in the description 133 is output. A difficulty level in the description 135 is the level defined by “difficulty” in the descriptions 71a and 71b in FIGS. 7A and 7B described above. Although “difficulty” is defined in three steps of “high”, “medium”, and “low” in the present embodiment, it may not be limited to these. A migration procedure in the description 136 is an item designated by “instruction” in the descriptions 71a and 71b in FIGS. 7A and 7B.

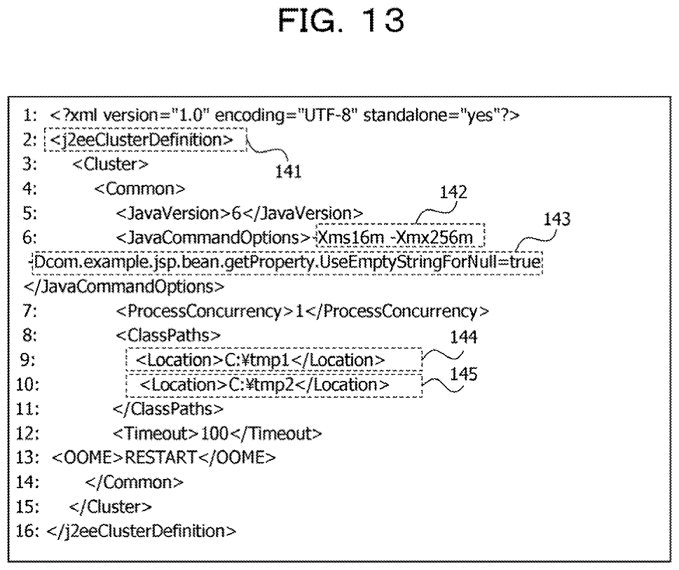

An example of specific processing in the present embodiment will be described by using an example of the system definition information file illustrated in FIG. 13.

First, to identify the file type of the system definition information file in FIG. 13, the identification unit 13 reads a portion from the head to the second line of the system definition information file illustrated in FIG. 13. “J2eeClusterDefinition” corresponding to the file type identifying keyword appears in a description 141 on the second line in FIG. 13. Thus, by referring to the file type identifying keyword 31 in the data line 34 of the file type identifying keyword list illustrated in FIG. 3, the identification unit 13 may identify the type of the system definition information file in FIG. 13 as the Cluster definition file.

Next, the detection unit 14 applies the incompatibility detection rules illustrated in FIG. 8 and detects the incompatibility that may occur in the system definition information file in FIG. 13. Since the type of the system definition information file in FIG. 13 has been identified as the Cluster definition file, the incompatibility detection rules to be applied are, for example, three rules in data lines 84, 85, and 86 in FIG. 8 corresponding to the Cluster definition file. The detection unit 14 detects incompatibilities by applying the three rules in the data lines 84 to 86 in FIG. 8.

In a description 143 on the sixth line in FIG. 13, the incompatibility detection keyword “-Dcom.example.jsp.bean.getProperty.UseEmptyStringForNull=true”, which is in the incompatibility portion 82 in the data line 84 of FIG. 8 appears. “J2eeClusterDefinition”, “Cluster”, “Common”, and “JavaCommandOptions” in the incompatibility portion 82 in the data line 84 in FIG. 8 indicate paths to the position where the incompatibility detection keyword appear, and correspond to the second, third, fourth, and sixth lines in FIG. 13, respectively. “contains(text( ),'-Dcom.example.jsp.bean.getProperty.UseEmptyStringForNull=true” indicates that “-Dcom.example.jsp.bean.getProperty.UseEmptyStringForNull=true” that appears in a tag of “JavaCommandOptions” is detected as an incompatibility. Accordingly, the detection unit 14 detects the description 143 on the sixth line in FIG. 13 as the incompatibility portion. “Xms16m” and “−Xmx256m” (a description 142 on the sixth line in FIG. 13) are described as examples of codes, and do not have to be described. The output unit 15 describes information on the detected incompatibility in No. 1 in FIG. 12 in accordance with the item described in the description 71a with reference to FIG. 7A.

Since the number of appearances 83 in the data line 84 in FIG. 8 is once, the incompatibility portion 82 in the data line 84 in FIG. 8 does not appear on the seventh and subsequent lines in FIG. 13 in the Cluster definition file in FIG. 13. Thus, in the incompatibility detection processing on the seventh and subsequent lines in FIG. 13, the detection unit 14 performs the incompatibility detection by using the rules in the data lines 85 and 86 as the incompatibility detection rules to be applied. For example, the detection unit 14 excludes the rule in the data line 84 from the rules to be applied to the subsequent processing, thereby reducing the number of incompatibility detection rules to be applied.

Incompatibility detection for a description 144 on the ninth line and a description 145 on the tenth line in FIG. 13 will be described. The incompatibility portion in the data line 85 in FIG. 8 indicates that, when all the paths “J2eeClusterDefinition”, “Cluster”, “Common”, “ClassPaths”, and “Location” are aligned in order, it is detected as the incompatibility detection keyword. Thus, the description 144 on the ninth line and the description 145 on the tenth line in FIG. 13 are detected as incompatibility portions because “J2eeClusterDefinition”, “Cluster”, “Common”, and “ClassPaths” match the second, third, fourth, and eighth lines in FIG. 13, respectively. The output unit 15 outputs the results to the report file by referring to the rule definition file in FIG. 7B. The output results are those indicated in No. 2 and No. 3 in FIG. 12.

The incompatibility detection processing performed on the eleventh and subsequent lines in FIG. 13 will be described. The number of appearances 83 in the data line 85 in FIG. 8 is “multiple”, and it is understood that the incompatibility in the data line 85 in FIG. 8 may appear a plurality of times in the Cluster definition file. Thus, there is a possibility that the incompatibility of No. 2 in FIG. 8 appears also in the eleventh and subsequent lines. For this reason, the detection unit 14 performs the detection of the incompatibility that occurs on the eleventh and subsequent lines of the Cluster definition file in FIG. 13 while keeping the incompatibility detection rules to be applied as in the data lines 85 and 86 in FIG. 8.

As described above, according to the incompatibility detection program of the present embodiment, the type of the system definition information file of the application is identified, and the incompatibility detection is performed by applying merely the incompatibility detection keyword corresponding to the identified type. Accordingly, it is possible to reduce the time taken to detect the incompatibility. In the present embodiment, the incompatibility detection processing may be omitted for a system definition information file of which the file type is not identified. Also in this aspect, in the present embodiment, it is possible to reduce the time taken to detect the incompatibility. For example, in the present embodiment, it is possible to reduce the time taken to detect the incompatibility in terms of both reduction in the number of incompatibility detection rules to be applied to one system definition information file and reduction in the number of system definition information files for which the incompatibility detection processing is to be performed.

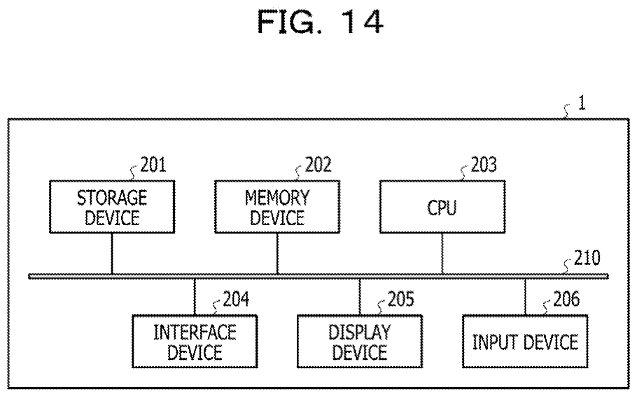

FIG. 14 is a diagram illustrating an example of a hardware configuration of the incompatibility detection apparatus 1 according to the present embodiment. In FIG. 14, the incompatibility detection apparatus 1 has a storage device 201, a memory device 202, a central processing unit (CPU) 203, an interface device 204, a display device 205, and an input device 206, which are coupled to each other by a bus 210.

A program for causing the incompatibility detection apparatus 1 to perform the processing is stored in, for example, the storage device 201 or the memory device 202. The program may not be stored in the storage device 201 from the beginning, and the program may be stored in a flexible disk, a magneto-optical disk, or the like that may be inserted into a computer. Alternatively, the program may be downloaded from another computer or another storage device via a network.

The CPU 203 performs arithmetic processing related to the incompatibility detection apparatus 1 in accordance with the program stored in the storage device 201 or the memory device 202. The interface device 204 is used for coupling to another device via a network. The display device 205 displays a graphical user interface (GUI) or the like based on the program. For example, the input device 206 is a keyboard, a mouse, or the like, and is used to input instructions for various operations. Although an example in which the incompatibility detection apparatus 1 according to the present embodiment is a single computer as illustrated in FIG. 14 has been described above, a specific hardware configuration of the incompatibility detection apparatus 1 may be changed as appropriate within a range in which the present disclosure may be realized. For example, the series of processing described in the present embodiment may be executed by a plurality of computers in cooperation with each other. A model number or performance of hardware used as the incompatibility detection apparatus 1 does not have to be uniquely limited.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an incompatibility detection program causing a computer to execute a process comprising:
identifying a type of a setting file of an application that operates in a first application execution environment; and
detecting an incompatibility that occurs in the setting file of which the type is identified, by applying merely an incompatibility detection rule corresponding to the identified type of the setting file among one or more incompatibility detection rules in each of which information on an incompatibility detection pattern for determining that the setting file includes an incompatibility that occurs along with migration from the first application execution environment to a second application execution environment different from the first application execution environment and information on the type of the setting file in which the incompatibility occurs are associated with each other.

2. The non-transitory computer-readable recording medium according to claim 1, wherein
in the identifying of the type of the setting file, a file type is identified in a case where a keyword for identifying the file type appears within a designated range from a head of the setting file.

3. The non-transitory computer-readable recording medium according to claim 1, wherein
in the detecting of the incompatibility, information on the detected incompatibility is output.

4. The non-transitory computer-readable recording medium according to claim 1, wherein
in response to detection of a first incompatibility, in the setting file of which the type is identified, as many times as a number of times the first incompatibility is to occur, the incompatibility detection rule related to the first incompatibility is excluded from the incompatibility detection rules corresponding to the identified type of the setting file, and processing of detecting the incompatibility is performed.

5. An incompatibility detection method comprising:
identifying, by a computer, a type of a setting file of an application that operates in a first application execution environment; and
detecting an incompatibility that occurs in the setting file of which the type is identified, by applying merely an incompatibility detection rule corresponding to the identified type of the setting file among one or more incompatibility detection rules in each of which information on an incompatibility detection pattern for determining that the setting file includes an incompatibility that occurs along with migration from the first application execution environment to a second application execution environment different from the first application execution environment and information on the type of the setting file in which the incompatibility occurs are associated with each other.

6. An information processing apparatus comprising:
a memory; and
a processor coupled to the memory and configured to:
identify a type of a setting file of an application that operates in a first application execution environment; and
detect an incompatibility that occurs in the setting file of which the type is identified, by applying merely an incompatibility detection rule corresponding to the identified type of the setting file among one or more incompatibility detection rules in each of which information on an incompatibility detection pattern for determining that the setting file includes an incompatibility that occurs along with migration from the first application execution environment to a second application execution environment different from the first application execution environment and information on the type of the setting file in which the incompatibility occurs are associated with each other.
